(19) United States
(12) Patent Application Publication
(10) Pub. No.: US 2012/0096796 A1
(43) Pub. Date: Apr. 26, 2012

(54) Waterproof masonry cement

(75) Inventor: Christopher J. Sieto, Warrington, PA (US)

(73) Assignee: Tomahawk, Inc.

(21) Appl. No.: 12/925,536

(22) Filed: Oct. 25, 2010

(51) Int. Cl. E04B 2/02; C04B 24/40

(52) U.S. Cl. 52/424; 106/806

(57) ABSTRACT

A waterproof masonry cement is disclosed. The masonry cement includes a waterproofing agent, in dry form, which is introduced into the cement during the grinding process. The waterproofing agent comprises siloxanes and alkoxysilanes and can also be introduced, in liquid form, into concrete blocks during the manufacture of same. In this manner, the concrete blocks incorporating the waterproofing agent along with the masonry cement containing the waterproofing agent can be utilized together to form a water repellant wall structure.

### TECHNICAL FIELD

The present invention relates, in general, to waterproof masonry cement, and, more particularly, to a masonry cement that incorporates a waterproofing agent, in dry form, and masonry wall systems that utilizing mortar and concrete block each containing a waterproofing agent.

### BACKGROUND ART

Typically, in order to produce a waterproof mortar, a liquid admixture must be added to masonry cement, water and sand. Since an admixture must be utilized during the mixing process, there is the possibility of dosage errors. In addition, since the admixture is typically in liquid form, there is a possibility that the admixture will freeze in cold weather. Furthermore, most admixtures contain stearates which wear away over time, thus increasing the possibility of efflorescence within the mortar and/or any concrete blocks which are joined by the mortar.

In view of the foregoing inherent disadvantages associated with presently available waterproof mortar, it has become desirable to develop a mortar having a dry waterproofing agent mixed therein to prevent the problems associated with dosage errors and/or freezing and which can be incorporated in the manufacturing process for concrete blocks or bricks.

### DESCRIPTION OF THE PREFERRED EMBODIMENT

The following description is directed to the preferred embodiment of the present invention, but is not intended to limit the invention disclosed herein. The present invention involves a masonry cement having waterproofing capabilities. The masonry cement is mixed with a dry powder which provides durable water repellency and excellent beading properties. The masonry cement with the waterproofing agent mixed therein is used to create mortar which is utilized to build concrete masonry walls that contain the waterproofing agent. The waterproofing agent, in liquid form, is added to the concrete block during the manufacturing process for same. The concrete blocks or bricks containing the waterproofing agent along with the masonry cement containing the waterproofing agent mixed therein can be utilized together to provide a water repellant wall system.

The present invention is directed to a masonry cement having a dry waterproofing agent mixed therein. The waterproofing agent includes siloxanes and alkoxysilanes in an inorganic carrier. By introducing the waterproofing agent into the mortar during the mixing process, any error in dosage which can occur through the use of an admixture, as in the prior art, can be avoided. In addition, the use of a dry waterproofing agent eliminates the problem of freezing which can occur with the use of a liquid admixture, as in the prior art. When combined with sand and water, the masonry cement containing the waterproofing agent (siloxanes and alkoxysilanes) produces a mortar having excellent water repelling and beading properties.

A typical masonry cement has the following composition:

| | %, by weight |
|---|---|
| SiO2 | 15-30 |
| Al2O3 | 0-10 |
| Fe2O3 | 0-10 |
| CaO | 50-70 |
| MgO | 0-5 |
| SO3 | 0-5 |
| Na20 | 0-1 |
| K20 | 0-1 |
| Tio2 | 0-1 |
| MnO3 | 0-1 |
| P2O5 | 0-1 |
| Cl | 0-1 |
| SrO | 0-1 |
| ZnO | 0-1 |

Such a masonry cement might also include calcium stearate in the range of 0.5% to 2.5% by weight

In the present invention, the calcium stearate has been removed from the masonry cement and replaced with a dry waterproofing agent that is added to the cement during the mixing process. This dry waterproofing agent has the following composition:

| | %, by weight |
|---|---|
| C14H32O3Si | 20-40 |
| Si | >40 |

When this waterproofing agent is added to a typical masonry cement, such as the composition that was previously described, the percentage, by weight, of this waterproofing agent within such a masonry cement composition is as follows:

| | %, by weight |
|---|---|
| C14H32O3Si | 0-5 |
| Si | 0-5 |

When adding this waterproofing agent to concrete masonry block or brick during the manufacturing process for same, it is typically introduced in liquid form and in a similar dosage. Thus, the present invention can be utilized to provide a masonry cement having waterproofing capabilities through the use of a dry waterproofing agent. In addition, concrete blocks or bricks can be produced by introducing the waterproofing agent of the present invention in liquid form into the concrete blocks or bricks during the manufacturing process for same. The masonry cement of the present invention containing the dry waterproofing agent can be added to water and sand forming a mortar for joining concrete blocks or bricks containing the waterproofing agent to produce a wall structure having excellent waterproofing capabilities. It has been found that efflorescence is substantially reduced or eliminated in such wall structures since stearates, which wear away over time increasing the possibility of efflorescence, are not present, and moisture on the surface of the wall structure is minimized. Moisture, along with pressure and salts, is required in order to create efflorescence.

Certain modifications and improvements will occur to those skilled in the art upon reading the foregoing. It is understood that all such modifications and improvements have not been included herein for the sake of brevity and conciseness, but are within the scope of the following claims.

I claim:

1) A cement mixture including a waterproofing agent comprising siloxanes and alkoxysilanes.

2) The cement mixture as defined in claim 1 wherein said waterproofing agent is in powder form.

3) The cement mixture as defined in claim 1 wherein said waterproofing agent is mixed into said cement during the grinding process of said cement.

4) The cement mixture as defined in claim 1 wherein said waterproofing agent comprises C14H32O3Si and Si.

5) The cement mixture as defined in claim 4 wherein said C14H32O3Si is about 0 to 5% by weight of said cement mixture and said Si is about 0 to 5% by weight of said cement mixture.

6) The combination of cement mortar and concrete blocks forming a wall structure wherein said cement mortar and said concrete blocks include a waterproofing agent comprising siloxanes and alkoxysilanes.

7) The combination as defined in claim 6 wherein said waterproofing agent for said cement mortar is in powder form when mixed into said cement during the grinding process of said cement and said waterproofing agent for said concrete blocks is in liquid form when introduced into said concrete blocks during the manufacture thereof.

8) The combination as defined in claim 6 wherein said waterproofing agent comprises C14H32O3Si and Si.
